(19) United States
(12) Patent Application Publication
(10) Pub. No.: US 2021/0401170 A1
(43) Pub. Date: Dec. 30, 2021

(54) KITCHEN FURNITURE ITEM HAVING A SPECIAL CLOSURE ELEMENT

(71) Applicant: Bulthaup GMBH & CO. KG, Bodenkirchen (DE)

(72) Inventor: Marc Oliver Eckert, Bodenkirchen (DE)

(21) Appl. No.: 17/269,843

(22) PCT Filed: Aug. 20, 2019
(86) PCT No.: PCT/EP2019/072252

§ 371 Date: Jun. 14, 2021

(30) Foreign Application Priority Data
Aug. 20, 2018 (DE) 10 2018 120 224.5

(51) Int. Cl. A47B 77/02; E05D 11/10; E05F 3/20

(52) U.S. Cl. CPC A47B 77/02; E05D 11/1007; E05Y 2900/20; E05D 11/1014; E05F 3/20

(57) ABSTRACT

The invention relates to a kitchen furniture item having a carcass and an interior at least partially enclosed by the carcass, wherein the interior has a front-side access opening which is covered by means of a plate-shaped closure element (21, 22) which lies in a front plane of the carcass and can be reversibly opened and closed by a user, wherein the closure element has a plate-shaped pivoting part (21) and a likewise plate-shaped pulling part (22), and wherein a horizontal edge of the pivoting part (21) runs along a horizontal edge of the pulling part (22), and the parts are connected to one another at these common edges in such a way that, in order to open a first portion of the interior, the pivoting part (21) can be pivoted about a horizontal axis such that it bears against the front side of the pulling part (22).

The invention relates to a piece of kitchen furniture having a special closure element.

Various pieces of kitchen furniture are known from the prior art that serve the storage of kitchen utensils such as kitchen knives, flatware, plates, pots, or the like. To avoid an overloaded visual impression and to additionally avoid dust accumulation in the storage areas, the storage areas are frequently surrounded by a carcass and have a front-side access opening that is covered by a board-like closure element that is disposed in a frontal plane of the carcass and can be reversibly opened and closed by a user.

The most varied variants are known as regards the board-like closure elements. The by far most frequently used closure elements comprise pivot flaps, pivot doors, and drawer fronts.

It is the object of the invention to provide a new concept to close storage areas of pieces of kitchen furniture in a practical manner.

Against this background, the invention relates to a piece of kitchen furniture having a carcass and having an inner space at least partially surrounded by the carcass, wherein the inner space has a front-side access opening that is covered by a board-like closure element that is disposed in a frontal plane of the carcass and can be reversibly opened and closed by a user, wherein the closure element comprises a board-like pivot part and a likewise board-like pulling part, and wherein a horizontal edge of the pivot part extends along a horizontal edge of the pulling part and the parts are connected to one another at these common edges such that the pivot part can be pivoted about a horizontal axis to open a first section of the inner space such that it abuts the front side of the pulling part.

A first section of the inner space can therefore be reached by a pivoting of the pivot part about a horizontal axis. The pivoting preferably takes place in this process by exactly 180° so that the previously parallel front surfaces of the parts again contact one another in parallel after the pivoting. A special feature of the invention is in particular the fact here that the pivot part is pivotably supported at the pulling part and not at the carcass, for instance.

The piece of kitchen furniture can have a plurality of inner space sections or inner spaces, with only one of the sections or inner spaces being closed by the closure element configured in accordance with the invention. The closure element can also have even further board-like sections beside the two parts, i.e. beside the pivot part and the pulling part. It is, however, preferred that the closure element consists of these two board-like sections and the corresponding installation elements.

Suitable elements for connecting the pivot part to the pulling part comprise hinges, half-shafts, or other known elements.

It is preferred that the pulling part is fastened to a pullout and can be pulled from the carcass in a translatory manner to open a second section of the inner space. A second section of the inner space can therefore be reached by a pulling out of the pulling part, with the pivot part already frontally contacting this pulling part. The opening sequence therefore necessarily takes place in the order that a first section of the inner space is opened first by pivoting the pivot part before a second section of the inner space is opened by pulling out the pulling part.

Suitable elements for connecting the pulling part to the carcass comprise drawer runners or other known elements.

Both the pivot part and the pulling part are preferably configured as handle-less in order not to impair a planar lying of the front of the pivot part on the front of the pulling part.

The pulling part can be a front board of a drawer that further has a base that can be pulled out together with the pulling part and optionally has side walls and/or a rear wall. The drawer can be subdivided and have a plurality of compartments.

It is further preferred that the pulling part is disposed beneath the pivot part. The pivot part in this variant is therefore pivoted downwardly to open the first section of the inner space. The first inner space section is disposed above the second inner space section. This has the advantage that the pivot part cannot fall back into the closed position on its own, but that gravity rather acts thereon such that the pivot part remains in the upwardly pivoted state until it is pivoted closed again.

A damper is provided in an embodiment to brake the pivot movement of the pivot part. It is thus prevented that the pivot part accelerates after the start of the pivot movement and impacts the end point at high speed on the opening or closing depending on whether it is disposed at the top or bottom.

Provision can be made that the pivot part is supported such that it can also adopt a horizontal position and is held in a stable manner there. It can thus serve as a tray below the first inner space section provided that the pulling part is disposed below the pivot part.

The pivot part and the carcass can have corresponding pairs of holding means to hold the pivot part in the closed position such that it can only be pulled out of the closed position by an additional effect of force. Suitable holding means comprise, for example, corresponding pairs of magnets or magnetizable elements or corresponding parts of a releasable plug-in connection. This is in particular important if the pivot part is disposed above the pulling part to prevent an unwanted pivoting upward due to the effect of gravity.

The pulling part and the carcass can also have corresponding pairs of holding means to hold the pulling part in the closed position such that it can only be pulled out of the closed position by an additional effect of force. Suitable holding means comprise, for example, corresponding pairs of magnets or magnetizable elements or corresponding parts of a releasable plug-in connection. An unwanted opening of the pulling part is thus prevented.

Ultimately, the pivot part and the pulling part can also have corresponding pairs of holding means to hold the front of the open pivot part at the front of the pulling part such that it can only be pulled out of the completely open position again by an additional effect of force. Suitable holding means again comprise, for example, corresponding pairs of magnets or magnetizable elements or corresponding parts of a releasable plug-in connection. If the pulling part and the carcass also have corresponding pairs of holding means, the holding means holding the pivot part and the pulling part to one another are preferably configured as weaker in order not to release the pulling part from the carcass in an unwanted manner on a releasing of the front of the open pivot art.

Provision is made in an embodiment that the carcass comprises a push open fitting to release the pivot part and/or the pulling part from the closed position. Such push open fittings are frequently also called push to open fittings. A plunger of the fitting is activated by a brief pushing impulse on the front of the closure element and presses the closure element forward. The opening movement of the pivot part and/or the translatory opening movement of the pulling part can thus be initiated by a pushing impulse on the front of the respective part. This facilitates a handle-less configuration.

At least one pullout, preferably at least one drawer, that becomes accessible after opening the pivot part, can be arranged in the first section of the inner space. Various kitchen utensils such as kitchen knives, flatware, etc. can be stored in such drawers, for example.

The second inner space section can, for example, be used for storing plates or pots.

The piece of kitchen furniture can, for example, be a sideboard whose surface is formed by a flat work surface or storage board.

A piece of kitchen furniture in accordance with the invention can be arranged horizontally or vertically. A lying alignment of a piece of kitchen furniture in accordance with the invention is equally conceivable in which the closure element is preferably arranged at an upper side of the piece of kitchen furniture. Ultimately, the arrangement of a piece of kitchen furniture in accordance with the invention is variable and can be flexibly adapted to a respective use.

Further details and advantages of the invention result from the embodiments discussed in the following with reference to the Figures. There are shown in the

### FIGURES

FIG. 1: a perspective view of a piece of kitchen furniture with a closed closure element;

FIG. 2: views to illustrate a partial procedure on the opening of the closure element of this piece of kitchen furniture; and

FIG. 3: views to illustrate a further partial procedure on the opening of the closure element of this piece of kitchen furniture.

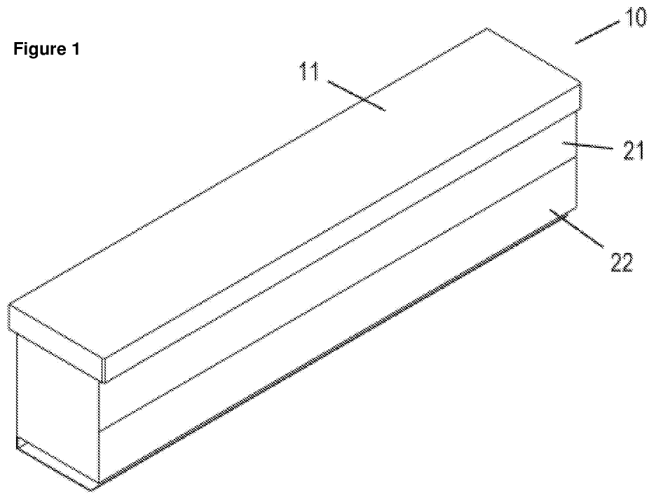

In FIG. 1, a piece of kitchen furniture in accordance with the invention is shown in the form of a sideboard 10. The sideboard 10 comprises a carcass that surrounds an inner space having a plurality of storage areas as will be explained in detail further below. The upper side of the carcass is formed by a flat worktop or storage board 11.

A vertical closure board 20 that is composed of an upper part 21 and a lower part 22 is located at the front of the carcass. Both the parts 21 and 22 have the same dimensions and have the shape of elongate boards that are aligned in a vertical plane and are disposed transversely. The parts 21 and 22 contact one another along a common horizontal longitudinal edge, with the horizontal lower edge of the upper part 21 extending along the horizontal upper edge of the lower part 22.

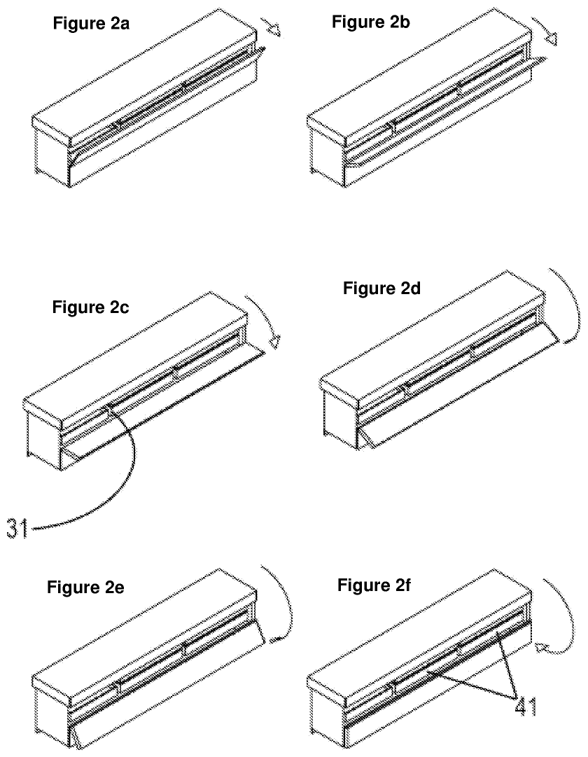

The upper part 21 is connected to this common edge by hinges such that it can be pivoted downward by 180° about a horizontal axis extending at the common edge to open an upper section 31 of the inner space such that its flat front lies on the likewise flat front of the lower part 22. This procedure is illustrated in FIGS. 2a-2f:

To prevent an unwanted pivoting up of the upper part 31 due to the effect of gravity, the upper part 21 and the carcass comprise corresponding parts of magnetic elements to hold the upper part 21 absent an additional effect of force of the closed position.

The upper part 21 is formed as handle-less in order not to impair a planar lying of its front at the front of the lower part 22 likewise formed as handle-less. To make it possible for a user to open the upper part 21, the carcass comprises a push to open fitting that pushes the upper part 21 forward in response to a brief pushing impulse on the front of the upper part 21 and overcomes the retention force of the corresponding magnetic elements.

To brake the pivot movement of the upper part 21 and to prevent the upper part 21 form abruptly flipping down after overcoming the retention force of the corresponding magnetic elements, a damper is provided that exerts a braking force on the upper part 21 that acts against gravity and thus ensures a uniformly slow movement of the upper part 21 on the pivoting up.

A plurality of drawers 41 for storing smaller kitchen utensils such as kitchen knives, flatware, or the like are located within the upper inner space section 31 that is released on the flipping up of the upper part 21. The drawers 41 themselves are likewise configured as handle-less and can be opened by gripping behind the upper edge of the drawer front.

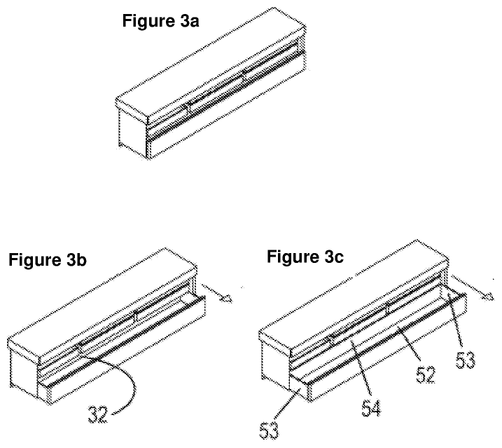

The lower part 22 represents the front board of a drawer that furthermore has a base 52, left and right side walls 53, and a rear wall 54. The drawer is not subdivided and has one large storage space. To open the drawer, the lower part 22 which the upper part 21 that has been pivoted up contacts can be gripped behind and pulled out by a user at the now common upwardly oriented edges of the lower part 22 and the upper part 21. This procedure is illustrated in FIGS. 3a-3c:

The drawer comprising a lower part 22, a base 52, side walls 53, and a rear wall 54 can be used for storing larger kitchen utensils such as plates or pots.

1. A piece of kitchen furniture having a carcass and an inner space at least partially surrounded by the carcass, wherein the inner space has a front-side access opening that is covered by a board-like closure element that is disposed in a frontal plane of the carcass and can be reversibly opened and closed by a user,
the closure element comprising a board-like pivot part and a likewise board-like pulling part, with a horizontal edge of the pivot part extending along a horizontal edge of the pulling part and the parts being connected to one another at these common edges such that the pivot part can be pivoted about a horizontal axis to open a first section of the inner space such that it contacts a front side of the pulling part.

2. The piece of kitchen furniture in accordance with claim 1, wherein the pulling part is fastened to a pullout and can be pulled from the carcass in a translatory manner to open a second section of the inner space.

3. The piece of kitchen furniture in accordance with claim 2, wherein the pulling part is a front board of a drawer that further has a base that can be pulled out together with the pulling part and has side walls and/or a rear wall.

4. The piece of kitchen furniture in accordance with claim 1, wherein the pulling part is disposed below the pivot part.

5. The piece of kitchen furniture in accordance with claim 1, wherein a damper is provided to brake the pivot movement of the pivot part.

6. The piece of kitchen furniture in accordance with claim 1, wherein the pivot part and the carcass have corresponding pairs of holding means to hold the pivot part in the closed position such that it can only be pulled out of the closed position by an additional effect of force.

7. The piece of kitchen furniture in accordance with claim 1, characterized in that wherein the pulling part and the carcass have corresponding pairs of holding means to hold the pulling part in the closed position such that it can only be pulled out of the closed position by an additional effect of force.

8. The piece of kitchen furniture in accordance with claim 1, wherein the pivot part and the pulling part have corresponding pairs of holding means to hold the front of the open pivot part at the front of the pulling part such that it can only be pulled out of the completely open position again by an additional effect of force.

9. The piece of kitchen furniture in accordance with claim 1, characterized in that wherein the carcass comprises a press to open fitting to release the pivot part and/or the pulling part from the closed position.

10. The piece of kitchen furniture in accordance with claim 1, wherein at least one pullout part, comprises at least one drawer, that becomes accessible after opening the pivot part, arranged in the first section of the inner space.

11. The piece of kitchen furniture in accordance with claim 1, wherein the pulling part is fastened to a pullout and can be pulled from the carcass in a translatory manner to open a second section of the inner space and wherein the pulling part is disposed below the pivot part.

12. The piece of kitchen furniture in accordance with claim 11, wherein a damper is provided to brake the pivot movement of the pivot part.

13. The piece of kitchen furniture in accordance with claim 12, wherein the carcass comprises a press to open fitting to release the pivot part and/or the pulling part from the closed position.

14. The piece of kitchen furniture in accordance with claim 12, wherein the pivot part and the carcass have corresponding pairs of holding means to hold the pivot part in the closed position such that it can only be pulled out of the closed position by an additional effect of force.

15. The piece of kitchen furniture in accordance with claim 12, wherein the pulling part and the carcass have corresponding pairs of holding means to hold the pulling part in the closed position such that it can only be pulled out of the closed position by an additional effect of force.

16. A piece of kitchen furniture in accordance with claim 12, wherein the pivot part and the pulling part have corresponding pairs of holding means to hold the front of the open pivot part at the front of the pulling part such that it can only be pulled out of the completely open position again by an additional effect of force.

17. The piece of kitchen furniture in accordance with claim 12, wherein at least one pullout part comprises at least one drawer, that becomes accessible after opening the pivot part, arranged in the first section of the inner space.

18. The piece of furniture in accordance with claim 1, wherein the closure element and the carcass comprise corresponding parts of magnetic elements.

19. The piece of kitchen furniture in accordance with claim 18, wherein a damper is provided to brake the pivot movement of the pivot part.

20. The piece of kitchen furniture in accordance with claim 19, wherein the pulling part is a front board of a drawer that further has a base that can be pulled out together with the pulling part and has side walls and/or a rear wall.
